(19) United States
(12) Patent Application Publication
(10) Pub. No.: US 2021/0056553 A1
(43) Pub. Date: Feb. 25, 2021

(54) Automatic Account Identifier Detection and Authorization

(71) Applicant: Visa International Service Association, San Francisco, CA (US)

(72) Inventor: Kelvan Patrick Howard, San Francisco, CA (US)

(21) Appl. No.: 16/543,926

(22) Filed: Aug. 19, 2019

(51) Int. Cl. G06Q 20/40; G06Q 10/10; G06Q 20/36; G06Q 20/32

(52) U.S. Cl. CPC G06Q 20/4016; G06Q 20/3224; G06Q 20/36; G06Q 10/1095

(57) ABSTRACT

A computer-implemented method, computer program product, and system related to automatically updating a consumer's location with a service provider to ensure the desired performance of a consumer's services.

### BACKGROUND

### 1. Technical Field

The present disclosure relates to systems, methods, techniques, computer program products, instruction sequences, and computing machine program products associated with and configured to the technical field of special purpose machines that facilitate generation and provision of application program interfaces (APIs). The APIs automatically communicate notifications to update user information to service providers, such as financial networks, communication networks, or digital content providers based on extracted user geographic data or calendar data, using Artificial Intelligence or machine intelligence.

### 2. Technical Considerations

Although consumers are increasingly mobile, the technology associated with most service providers has not advanced to accommodate a consumer's mobile patterns. For example, when traveling, consumers commonly carry mobile devices and portable financial devices (e.g., credit cards and/or debit cards) that may be linked to various consumer accounts for transacting with merchants. With the increased ease of travel, consumers often travel outside of their previously designated “home” location where banks have authorized their portable financial devices to transact. Because of the growing frequency of travel and e-commerce, consumers are increasingly able to make purchases from merchants located anywhere in the world. Unfortunately, a commensurate increase in fraudulent transactions and consumer identity theft has accompanied the expansion of e-commerce and travel. From the point of view of current fraud models, a consumer-initiated transaction in a foreign country during the consumer's international travel may appear identical to an unauthorized transaction resulting from fraud or identity theft. Consequently, portable financial device issuers and networks expend increasingly substantial resources on efforts to reduce the fraud associated with unauthorized transactions and increase their ability to recognize authorized, consumer-approved transactions and spend patterns.

Portable financial device issuers and payment networks typically expend large amounts of resources on transaction models and consumer purchase profiles to better detect fraudulent transactions. Because the majority of transaction risk models are based upon the regular transaction patterns for a specific portable financial device in a consumer's home area, an issuer or payment network will likely register as fraudulent any deviation from a consumer's regular transaction patterns. A fraud designation on a specific portable financial device account may lead an issuer or network to temporarily or permanently suspend activity on the financial device, dramatically affecting a consumer's access to services and products. This action could frequently lead to a consumer's portable financial device (in this case, credit card or digital wallet) being suspended while a consumer is out of their home location and can result in the consumer's lost access to critical services.

Consumer mobility also affects the delivery of goods by a service provider (such as a courier or digital content provider). Many consumers have subscriptions to digital streaming content services. The service providers for the streaming content services have licensing agreements in place that restrict the content to residents or particular regions. Even if a consumer has an active subscription to content, their access to the service may be limited or suspended while they are out of their home location because the digital content service provider cannot distinguish between unauthorized access outside of prescribed region or access by an authorized user who is traveling outside of their home zone. Currently, if a consumer purchases goods for later delivery, couriers typically give consumers a delivery window of a couple of hours to several weeks. For increasingly mobile consumers, this often results in the consumer missing the delivery due to a consumer's other schedule constraints.

As consumers and manufacturers connect more devices to the Internet, consumers will have access to an ever-growing number of services and devices that automatically purchase previously determined amounts of goods and services based on the consumer's regular usage patterns. A consumer's unexpected deviation from their home-location and/or use-patterns may result in the unwanted purchase and/or delivery of an un-needed good or service.

Therefore, there is a need in the art for an improved way of automatically identifying an authorized change in a consumer's regular travel, transaction, and/or consumption patterns, and updating service providers to ensure the desired performance of the consumer's services.

### SUMMARY

In one example, the disclosure is directed to a method that includes inferring, by a computing system, based on information associated with a user of a user resource, the location of a user at a specific time and then utilizing consumer mobile data and special purpose computers to update the user's associated service providers. According to some non-limiting embodiments or aspects, provided are a computer implemented method, system, and hardware for detecting, authorizing, and updating at least one account identifier for at least one user.

According to some non-limiting embodiments or aspects, provided is a method comprising: accessing, with at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

In some non-limiting embodiments or aspects, the at least one API request further comprises information related to financial instruments registered to the user.

In some non-limiting embodiments or aspects, the method further comprises: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

In some non-limiting embodiments or aspects, the user reply to the notification comprises confirmation or denial of the authorization request.

In some non-limiting embodiments or aspects, the user reply to the notification comprises a biometric parameter, a password, a passcode, or multi-factor authentication.

In some non-limiting embodiments or aspects, the disclosure is directed to a hardware device storing instructions that when executed by one or more processors, infer, by a computing system, based on information associated with a user of a user resource, the location of a user at a specific time and updating the user's associated service providers.

According to some non-limiting embodiments or aspects, provided is a computer program product storing instructions that, when executed by one or more processors, cause the one or more processors to perform operations comprising: accessing, with at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

In some non-limiting embodiments or aspects, the at least one API request further comprises information related to financial instruments registered to the user.

In some non-limiting embodiments or aspects, the computer program product further comprises: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

In some non-limiting embodiments or aspects, the user reply to the notification comprises confirmation or denial of the authorization request.

In some non-limiting embodiments or aspects, the user reply to the notification comprises a biometric parameter, a password, a passcode, or multi-factor authentication.

In some non-limiting embodiments or aspects, the disclosure is directed to a computing system, comprising one or more processors and a computer program product storing instructions that when executed by the one or more processors, infer, based on information associated with a user of a user resource, the location of a user at a specific time and updating the user's associated service providers.

According to some non-limiting embodiments or aspects, provided is a system, comprising one or more hardware processors, and a storage device storing instructions that, when executed by the one or more hardware processors, causes the one or more hardware processors to perform operations comprising: accessing, with at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

In some non-limiting embodiments or aspects, the at least one API request further comprises information related to financial instruments registered to the user.

In some non-limiting embodiments or aspects, the operations performed by the system further comprise: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

In some non-limiting embodiments or aspects, the user reply to the notification comprises confirmation or denial of the authorization request.

In some non-limiting embodiments or aspects, the user reply to the notification comprises a biometric parameter a password, a passcode, or two-factor authentication.

Further non-limiting embodiments or aspects are set forth in the following numbered clauses:

Clause 1. A computer-implemented method for automatically detecting and authorizing at least one account identifier of a user, comprising: accessing, with at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to the extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

Clause 2. The method of clause 1, wherein the at least one API request further comprises information related to financial instruments registered to a digital wallet of the user.

Clause 3. The method of clause 1 or 2, further comprising: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

Clause 4. The method of any of clauses 1-3, wherein the user reply to the notification comprises confirmation or denial of the authorization request.

Clause 5. The method of any of clauses 1-4, wherein the user reply to the notification comprises a biometric parameter, a password, a passcode, or multi-factor authentication.

Clause 6. A computer program product storing instructions that, when executed by one or more processors, cause the one or more processors to perform operations comprising: accessing, using at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to the extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

Clause 7. The computer program product of clause 6, wherein the at least one API request further comprises information related to financial instruments registered to a digital wallet of the user.

Clause 8. The computer program product of clause 6 or 7, further comprising: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

Clause 9. The computer program product of any of clauses 6-8, wherein the user reply to the notification comprises confirmation or denial of the authorization request.

Clause 10. The computer program product of any of clauses 6-9, wherein the user reply to the notification comprises a biometric parameter, a password, a passcode, or multi-factor authentication.

Clause 11. A system, comprising: one or more hardware processors; and a storage device storing instructions that, when executed by the one or more hardware processors, causes the one or more hardware processors to perform operations comprising: accessing, using at least one processor, calendar data of a user, the user calendar data comprising at least one event associated with the user; extracting, with at least one processor, from the user calendar data, event data associated with the at least one event, the event data comprising at least one of the following: geographic data, chronological data, or any combination thereof; determining with at least processor, geolocation data for the user, the geolocation data comprising geographic data of the user at a specified time; modifying, with at least one processor, the geolocation data to comprise the extracted event data; in response to determining that the modified geolocation data corresponds to the extracted event data, automatically constructing, with at least one processor, at least one application program interface (API) request comprising the modified geolocation data; transmitting, with at least one processor, the at least one API request to a service provider server; and in response to the transmitting, receiving, with at least one processor, at least one message from the service provider server, the at least one message comprising: an authorization request to update the geographic data of the user of the service provider; or a confirmation that the geographic data of the user of the service provider has been updated.

Clause 12. The system of clause 11, wherein the at least one API request further comprises information related to financial instruments registered to a digital wallet of the user.

Clause 13. The system of clause 11 or 12, wherein the operations further comprise: detecting, with at least one processor, an application security level associated with the authorization request; configuring, with at least one processor, a notification based on the application security level associated with the authorization request; presenting, with at least one processor, the notification to the user, the notification comprising information associated with the authorization request; receiving, with at least one processor, a user reply to the notification; transmitting, with at least one processor, the user reply to the notification to the service provider server; and in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

Clause 14. The system of any of clauses 11-13, wherein the user reply to the notification comprises confirmation or denial of the authorization request.

Clause 15. The system of any of clauses 11-14, wherein the user reply to the notification comprises a biometric parameter, a password, a passcode, or multi-factor authentication.

### BRIEF DESCRIPTION OF THE DRAWINGS

The above and other aspects, features, and advantages of the present disclosure are illustrated by way of example and not limitation in the following detailed description taken in conjunction with the accompanying drawings.

FIG. 1. is a diagram of a non-limiting embodiment or aspect of an environment that illustrates the type of data comprising the geolocation data according to some non-limiting embodiments or aspects;

FIG. 2. is a diagram of a non-limiting embodiment or aspect of an environment that illustrates a digital communication network environment including a user resource and a service provider server according to some non-limiting embodiments or aspects; and

FIG. 3. is a diagram of a non-limiting embodiment or aspect of an environment that illustrates a digital communication network environment including a user resource and the service provider server according to some non-limiting embodiments or aspects.

### DETAILED DESCRIPTION

Hereinafter, embodiments of the present disclosure will be described with reference to the accompanying drawings; however, it should be understood that there is no intent to limit the present disclosure to the particular forms or examples disclosed herein. The specific details set forth are illustrative only and provide an understanding of various examples of the present subject matter. The present disclosure should be construed to cover various modifications, equivalents, and/or alternatives of the present disclosure's examples with the examples merely typifying possible variations. Unless explicitly stated otherwise, the structural elements described in the present disclosure are optional and may be combined or subdivided, and operations may vary in sequence or be combined or subdivided.

### Definitions

As used herein, the expressions “comprise,” “may comprise,” “have,” “may have,” “include,” and “may include” refer to the existence of a corresponding feature, such as a numeral, function, operation, or constituent element (such as a component) and do not exclude one or more additional features.

The “user resource,” according to the examples of the present disclosure, may include at least one of, for example, a mobile device, a smart phone, a feature phone, a tablet personal computer, a video phone, an electronic book (e-book) reader, a desktop PC, a laptop PC, a netbook computer, a workstation, a server, a personal digital assistant (PDA), a portable multi-media player, a wearable device, a smart watch, a connected ring, a connected bracelet, connected glasses, connected contact lenses, a virtual reality device, head-mounted device, a fabric integrated with an electronic chip or internet connectivity, a mobile medical device or some type of biophysical modification such as connected tattoo or bio-implant. According to some examples, the user resource may be a connected home appliance or a connected vehicle. The connected home appliance may include at least one of a television, a digital home assistant, a refrigerator, a vacuum cleaner, a microwave oven, a set-top box, a gaming console, or an electronic key. According to some examples, the user resource may include connected furniture or a connected building/structure. The user resource is not limited to the aforementioned devices and may include a future device according the development of technology.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “account identifier” may refer to one or more types of identifiers associated with a user account (e.g., an account identifier, a primary account number (PAN), a card number, a payment card number, a token, and/or the like). In some non-limiting embodiments or aspects, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payment transactions. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. In some non-limiting embodiments or aspects, the account identifier may be an original account identifier as chosen by or entered by a user at the creation of the account associated with the identifier (e.g., a username). For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “server” or “processor” may refer to one or more computing machines, such as processors, storage devices, and/or similar computer components that communicate with client devices and/or other computing machines over a network, such as the Internet or private networks, and, in some examples, facilitate communication among other servers and/or client devices. It will be appreciated that various other arrangements are possible. As used herein, the term “system” may refer to one or more computing machines or combinations of computing machines such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “computing machine” may refer to one or more computing devices or electronic devices that are configured to directly or indirectly communicate with or over one or more networks. The computing machine may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing machine may not be a mobile device, such as a desktop computer. Furthermore, the term “computer” may refer to any computing machine that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

Example systems, methods, techniques, computer program products, instruction sequences, and computing machine program products facilitate automatically determining user geolocation data to allow a user to authorize an update to a service provided by a service provider to the user. Example systems (e.g., special-purpose machines) are configured to access a user resource comprising a user's geolocation data that includes the user's geographic data and the user's calendar data. Some non-limiting embodiments or aspects provide mechanisms and logic that are capable of accessing the location services of a user resource to determine a user's geographic data as a function of time.

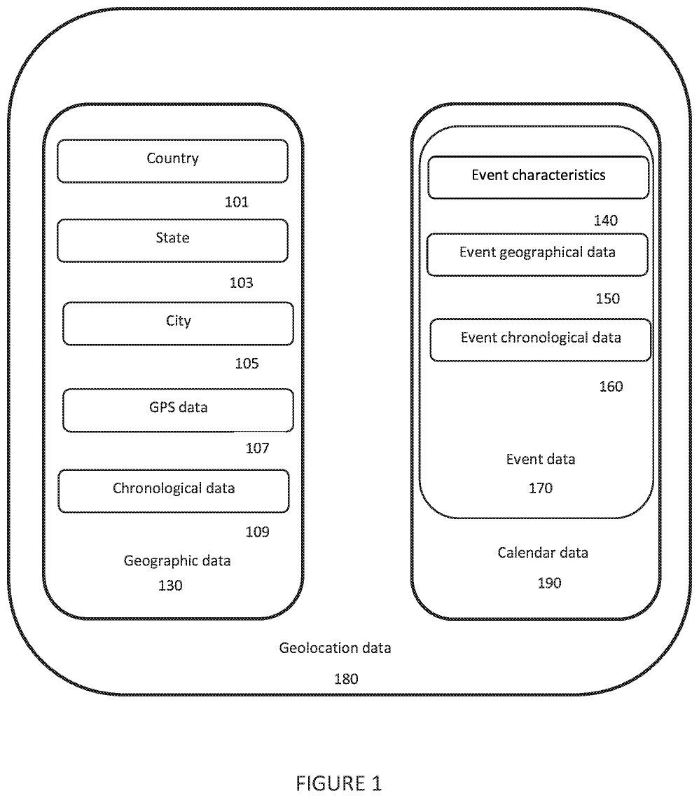

In some non-limiting embodiments or aspects, and as shown in FIG. 1, the user's geographic data 130 comprises information related to the users' location at a specified time, where the location information includes country 101, state 103, city 105, GPS data 107, and chronological data 109. Additionally, some non-limiting embodiments or aspects provide mechanisms and logic that are capable of accessing the calendar services of a user resource to determine a user's calendar data 190. As shown in the non-limiting embodiment or aspect of FIG. 1, the user's calendar data 190 comprises information on an event in which the user is or was scheduled to participate. In one example, the event data 170 may comprise event characteristics 140 (such as the nature of the event or method of travel to the event), event geographical data 150, and chronological data 160 characterizing the event.

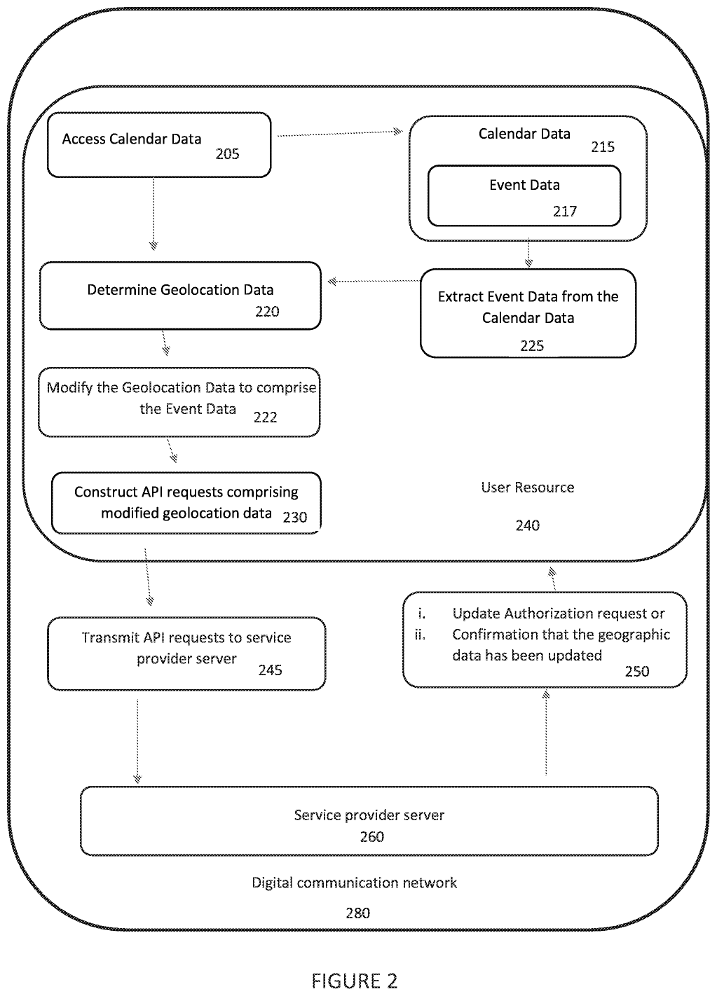

In some non-limiting embodiments or aspects, and as shown in FIG. 2, the user calendar data 215 is accessed (Step 205) from a user, utilizing at least one processor associated with the user resource. The calendar data 215 comprises event data 217 that is extracted (Step 225) from the calendar data 215 before determining the geolocation data (Step 220). The geolocation data 180 may be in the form of, include, or be modified to include geographic data 130, calendar data 190, 215, or any combination thereof. The geolocation data 220 may take the form of a database or data field that is configured to store geographic data 130, calendar data 215, or some combination of the two.

The geographic data determines the user location at a specific time and allows comparison with the user “home” location (where the user normally resides, receives a service, or is registered to receive a service). The user geographic data 130 defining the user location at a specific time may be a past, present, predicted, or future location as determined by the user resource GPS, the GPS logs, the IP address of a proxy server, the location of a mobile communication transmission tower to which the user resource has connected, or any suitable alternative method. In some non-limiting embodiments or aspects, the accessed calendar data 215 discloses the user location at a specific time by accessing the user calendar data via the user resource 240. The calendar data 215 discloses event data associated with a particular event in which the user is or was scheduled to participate. Consequently, the calendar data may be for a past, present, or future event. The accessing of the calendar data 215 via the user resource 240 to determine the geolocation data (Step 220) may be scheduled to occur randomly, at a regular frequency (e.g., on a particular day of the week or after a regular period of minutes, hours, or days), whenever the user resource 240 determines that it is no longer at the user home location, or at any other time interval. The time interval may be determined randomly, by a service provider, the user of the user resource, or by a computer algorithm (or artificial intelligence (AI) and/or machine learning) associated with the user resource 240 and/or service provider server 260. As discussed hereinafter, and in some non-limiting embodiments or aspects, based upon the determined geolocation data (Step 220) and the extracted event data (Step 225), the geolocation data will be modified (e.g., changed, updated, arranged, and/or the like) to comprise or include the extracted event data (Step 222).

In one exemplary and non-limiting embodiment or aspect, and upon determining the user geolocation data 220, the example systems, methods, techniques, computer program products, instruction sequences, and/or computing machine programs determine that three days prior, the user moved the user resource 240 from the user's home location of San Francisco to a user destination of New York, the user's determined geolocation data 220 will be modified (Step 222) to note that the user resource's geographic data for the last three days comprised a particular GPS location in New York City or a series of locations in the NYC area, within the state of New York, and within the United States. In an additional exemplary and non-limiting embodiment or aspect, accessing the user calendar data 215 may lead to the determination that the user was scheduled to fly to New York City via flight UA930 on United Airlines departing San Francisco at 11 am PST and arriving in New York City at 7:30 pm EST. In this example embodiment, information (in the form of event data 217) extracted 225 from the user calendar data 215 would reveal the user event data 217 (the flight to NYC, the return flight to San Francisco, and possible NYC lodging information). The revealed user event data 217 would then be used to modify the user geolocation data 220 to comprise the event data 217. In some non-limiting embodiments or aspects, the instructions to modify the geolocation data 220 to comprise the extracted event data 217 (Step 222) are executed by a modification module and/or computer program instructions comprising at least one processor.

After modifying the user geolocation data to comprise the event data (Step 220), the modified geolocation data may be processed to construct (Step 230) an application program interface (API) (e.g., an API call) comprising the modified geolocation data. The API request may comprise fields for entry or inclusion of information related to various aspects of the modified geolocation data. The fields may include a user geographic data 130 field (for country, state, city, or GPS data a specific time period) and/or may include a calendar data 190 field (characterizing an event 170 at a specific time). In some non-limiting embodiments or aspects, the fields may include multiple fields for geographic data 130 or multiple fields for the calendar data 190. In some non-limiting embodiments or aspects, the API request may comprise fields comprising information from both the geographic data 130 and the calendar data 190.

In some non-limiting embodiments or aspects, the API request is transmitted (Step 245), via a digital communications network 280, to the server 260 of a service provider associated with a service that the user receives or is registered to receive. The API requests may be transmitted to the server(s) of at least one service provider simultaneously, sequentially, in batches, or in any manner that allows transmission of the API requests. In some non-limiting embodiments or aspects, the user resource 240 may transmit the API requests or share the constructed API requests with at least one other user resource (in this exemplary embodiment, a second user resource) associated with the same user, such that the at least one other user resource may transmit the API requests to the service provider server 260. For example, the user resource 240 may comprise a user's smart watch which may not have full internet connectivity, but may be tethered, using Bluetooth® or WiFi®, to a user's connected mobile phone. In the instant example, the user's smart watch may construct, using one or more processors, the API requests and then share the requests with the user's mobile phone via their shared blue tooth connection such that the user's mobile phone is configured to transmit the API requests to the service provider server via the digital communication network 280.

The service providers may comprise digital content providers (such as Netflix®, Hulu®, Apple®, Google®, or Amazon®); financial networks (such as banks, issuers, digital wallet providers, credit card networks, or digital currency converters); delivery services (such as magazine services, Amazon®, InstaCart, UPS, USPS, or BlueApron); or Internet connected devices (such as a Nest thermometer, a connected home alarm, or home automation services like Apple's HomeKit). The types of service providers listed above are representative and not exhaustive. As an example, if the service provider is a digital content provider, updating the user's geolocation data with the service provider will allow user access to the service provider's digital content when the user resource is located in an area outside of the user's home location. The instant systems, methods, techniques, computer program products, systems, instruction sequences, and computing machine program products may allow the user (when travelling to a different country) access to digital content that was previously authorized for viewing only in the user's home location.

In some non-limiting embodiments or aspects, and if the service provider is a financial network, updating the user's geolocation data with the service provider may update the service provider's fraud prevention rules and travel notifications, such that a user's financial instruments (credit cards, ATM cards, digital wallets, etc.) will be automatically authorized to transact while the user is travelling without requiring the user to manually inform the service provider of their travel plans (as current systems require).

In some non-limiting embodiments or aspects where, for security reasons, authorization of the user account identifier requires input from the user, the input required to access the account associated with the identifier may take the form of any method that allows user interaction with the service provider and may be configured as a biometric input, passcode, password, a verbal command, a gesture, a specified interaction with the user resource, or a multi-factor authentication that requires more than one type of user action, or any other type of suitable reply.

In some non-limiting embodiments or aspects, and if the service provider is a delivery service, updating the user's geolocation data with the service provider may cancel or postpone previously-configured delivery orders so that delivery service does not deliver food or packages while the consumer is outside of their home location for an extended period of time. Alternatively, updating the user's geolocation data with the service provider may change the delivery address for previously-configured delivery orders to a different, user-designated address, such as the user's work address, the user's address at the proposed time of delivery, or an associate's address.

In some non-limiting embodiments or aspects, and if the service provider is a connected device, updating the user's geolocation data with the service provider may change the settings for a connected thermostat such that it will not heat the user's home until a previously-determined time before the user's return (based on the event data derived from the user's calendar data). Additionally, upon updating the user geolocation data, the connected device system may automatically execute an out-of-town lighting, heating, or security sequence in association with the user resource being located outside of the user's home location. According to an exemplary embodiment, upon updating the user geolocation data, the connected device system may automatically request instructions regarding an out-of-town lighting, heating, or security sequence in association with the user resource being located outside of the user's home location.

In response to transmitting the API requests (via a digital communications network 280) to the service provider server 260 (Step 245), and in some non-limiting embodiments or aspects, the service provider server 260 transmits to the user resource either an authorization request to update the user geographic data with the service provider or confirmation that the geographic data has been updated by the service provider server (Step 250). A plurality of authorization requests from different service providers may be aggregated into one communication with multiple fields, a burst of single or multiple communications, or maintained as a plurality of authorization requests and transmitted individually.

The application security level refers to the security level associated with a particular service provider. The application security level may be assigned by the user of the user resource, the service provider, or a third party associated with the user or the user resource. Additionally, the application security levels may differ for multiple services provided by the same service provider. The application security level defines a set of rules or parameters for effecting an update to a service provider. In some non-limiting embodiments or aspects, the update to a service provider comprises access to the service provider, access to a particular level of service, a change in a user's status with a service provider, a change in the service provider's records regarding information associated with the user, a transfer of service to a different service provider, a transfer of service to a difference user resource, and/or any other change in a user's relationship with a service provider.

In some non-limiting embodiments or aspects, the application security level includes logic determining the type of user input to the user resource required to update a service provider in response to the service provider's authentication request. For example, updates to a service provider may include updating a user's location with a financial network or updating a user's status with a connected device. The application security level may define rules for the type of notification that is presented to the user via the user resource in response to an authorization request to update the status of a user associated with the user resource. Additionally, the application security level may include logic that determines the type of user reply to the notification required to authorize or de-authorize an action. Furthermore, the application security level may employ machine learning or artificial intelligence to predict the type of notification presented to a user. The user reply to the notification defined by the application security level may comprise any method that allows user interaction with the notification and may be configured as a biometric input, passcode, password, a verbal command, a gesture, a specified interaction with the user resource, or a multi-factor authentication that requires more than one type of user action, or any other type of suitable reply.

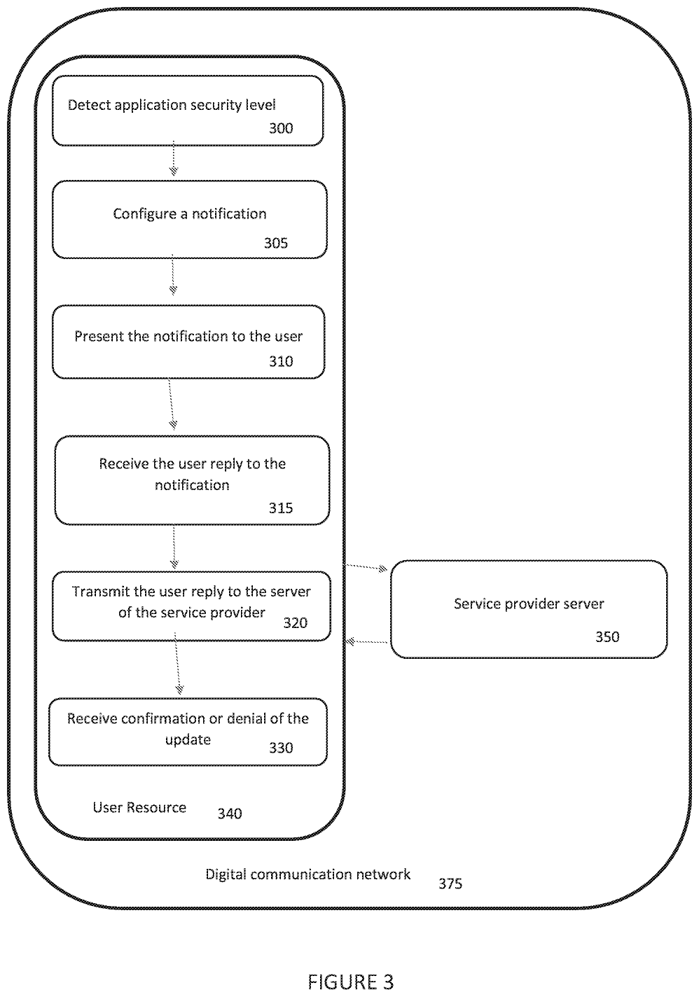

In some non-limiting embodiments or aspects, and as shown in FIG. 3 (with the steps occurring on or over a digital communication network 375), in response to the authorization request to update the modified user geolocation data with the service provider, the application security level associated with a service supplied by the service provider that transmitted the authorization request is detected (Step 300). After the detection of the application security level (Step 300), the appropriate notification is configured (Step 305) based on the parameters defined by the application security level and then presented to the user (Step 310). In some non-limiting embodiments or aspects, a graphical user interface (or GUI) may be presented to the user of the user resource, such that the GUI may comprises a plurality of notifications or a subset of the notifications.

In some non-limiting embodiments or aspects, the user resource 340 may present the notifications associated with different service providers in the order received from the service provider; as a curated list; in an order previously chosen by the user; in alphabetical order; based on an application security level associated with each authorization request; and/or any other method of presenting the notifications for user review. In some non-limiting embodiments or aspects, the user resource may use artificial intelligence, machine learning, and data processing algorithms to determine a likely presentation level for the notification or a response to the notification prior to presentation to the user. For some service providers or services, the application security level may be configured to automatically accept the authorization request without configuring or presenting a notification to the user. In cases where the notification is presented to the user (Step 310), the user resource may be configured to receive the user reply to the notification step 315.

In some non-limiting embodiments or aspects, and where the application security level defines the user reply to the notification as a biometric input, the user resource may be configured to accept a biometric input which may take the form of a finger print, retinal scan, voice biometric scan, palm scan, or any other biometric that the device is configured to accept. In some non-limiting embodiments or aspects, and where the application security level defines the user reply to the notification as a password input, the user resource is configured to display or accept a password input. This configuration may comprise presentation of a digital key board upon which the user may enter the passcode, presentation of a series of passwords from which a user may select the correct password, integration with a different device upon which a user might enter the password prior to the different device transmitting the password to the user resource, or any other suitable method of allowing user input. The user resource may be integrated with the different device through a physical connection or wirelessly.

With continued reference to FIG. 3, and in some non-limiting embodiments or aspects, upon receipt of the user reply to the notification, the user resource transmits to the service provider server 350 (Step 320) the results of the user reply to the notification so that the service provider can update its records associated with a service provided by the service provider to the user (if desired by the user). After receiving the transmission of the user reply, the service provider server sends confirmation or denial (Step 330) of the update to the user via the user resource 340.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific some non-limiting embodiments or aspects, various modifications and changes may be made to these embodiments without departing from the broader scope of embodiments of the present disclosure. For example, various embodiments or features thereof may be mixed and matched or made optional by a person of ordinary skill in the art. Such embodiments of the present subject matter may be referred to herein, individually or collectively, by the term “disclosure” merely for convenience and without intending to voluntarily limit the scope of this application to any single disclosure or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method for automatically detecting and authorizing at least one account identifier of a user, comprising:
a. accessing, with at least one processor, calendar data of a user, the user calendar data comprising at least one event associated with the user;
b. extracting, with at least one processor, from the user calendar data, event data associated with the at least one event, the event data comprising at least one of the following: geographic data, chronological data, or any combination thereof;
c. determining with at least processor, geolocation data for the user, the geolocation data comprising geographic data of the user at a specified time;
d. modifying, with at least one processor, the geolocation data to comprise the extracted event data;
e. in response to determining that the modified geolocation data corresponds to the extracted event data, automatically constructing, with at least one processor, at least one application program interface (API) request comprising the modified geolocation data;
f. transmitting, with at least one processor, the at least one API request to a service provider server; and
g. in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

2. The method of claim 1, wherein the at least one API request further comprises information related to financial instruments registered to a digital wallet of the user.

3. The method of claim 1, further comprising:
detecting, with at least one processor, an application security level associated with the authorization request;
configuring, with at least one processor, a notification based on the application security level associated with the authorization request;
presenting, with at least one processor, the notification to the user, the notification comprising information associated with the authorization request;
receiving, with at least one processor, a user reply to the notification;
transmitting, with at least one processor, the user reply to the notification to the service provider server; and
in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

4. The method of claim 3, wherein the user reply to the notification comprises confirmation or denial of the authorization request.

5. The method of claim 3, wherein the user reply to the notification comprises a biometric parameter, a password, a passcode, or multi-factor authentication.

6. A computer program product storing instructions that, when executed by one or more processors, cause the one or more processors to perform operations comprising:
a. accessing, using at least one processor, calendar data of a user, the user calendar data comprising at least one event associated with the user;
b. extracting, with at least one processor, from the user calendar data, event data associated with the at least one event, the event data comprising at least one of the following: geographic data, chronological data, or any combination thereof;
c. determining with at least processor, geolocation data for the user, the geolocation data comprising geographic data of the user at a specified time;
d. modifying, with at least one processor, the geolocation data to comprise the extracted event data;
e. in response to determining that the modified geolocation data corresponds to the extracted event data, automatically constructing, with at least one processor, at least one application program interface (API) request comprising the modified geolocation data;
f. transmitting, with at least one processor, the at least one API request to a service provider server; and
g. in response to the transmitting, receiving, with at least one processor, at least one message from the service provider server, the at least one message comprising: (i) an authorization request to update the geographic data of the user of the service provider; or (ii) a confirmation that the geographic data of the user of the service provider has been updated.

7. The computer program product of claim 6, wherein the at least one API request further comprises information related to financial instruments registered to a digital wallet of the user.

8. The computer program product of claim 6, further comprising:
detecting, with at least one processor, an application security level associated with the authorization request;
configuring, with at least one processor, a notification based on the application security level associated with the authorization request;
presenting, with at least one processor, the notification to the user, the notification comprising information associated with the authorization request;
receiving, with at least one processor, a user reply to the notification;
transmitting, with at least one processor, the user reply to the notification to the service provider server; and
in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

9. The computer program product of claim 8, wherein the user reply to the notification comprises confirmation or denial of the authorization request.

10. The computer program product of claim 8, wherein the user reply to the notification comprises a biometric parameter, a password, a passcode, or multi-factor authentication.

11. A system, comprising:
a. one or more hardware processors; and
b. a storage device storing instructions that, when executed by the one or more hardware processors, causes the one or more hardware processors to perform operations comprising:
i. accessing, using at least one processor, calendar data of a user, the user calendar data comprising at least one event associated with the user;
ii. extracting, with at least one processor, from the user calendar data, event data associated with the at least one event, the event data comprising at least one of the following: geographic data, chronological data, or any combination thereof;
iii. determining with at least processor, geolocation data for the user, the geolocation data comprising geographic data of the user at a specified time;
iv. modifying, with at least one processor, the geolocation data to comprise the extracted event data;
v. in response to determining that the modified geolocation data corresponds to the extracted event data, automatically constructing, with at least one processor, at least one application program interface (API) request comprising the modified geolocation data;
vi. transmitting, with at least one processor, the at least one API request to a service provider server; and
vii. in response to the transmitting, receiving, with at least one processor, at least one message from the service provider server, the at least one message comprising: an authorization request to update the geographic data of the user of the service provider; or a confirmation that the geographic data of the user of the service provider has been updated.

12. The system of claim 11, wherein the at least one API request further comprises information related to financial instruments registered to a digital wallet of the user.

13. The system of claim 11, wherein the operations further comprise:
detecting, with at least one processor, an application security level associated with the authorization request;
configuring, with at least one processor, a notification based on the application security level associated with the authorization request;
presenting, with at least one processor, the notification to the user, the notification comprising information associated with the authorization request;
receiving, with at least one processor, a user reply to the notification;
transmitting, with at least one processor, the user reply to the notification to the service provider server; and
in response to the transmitting, receiving, with at least one processor, at least one message from the service provider server, the at least one message comprising: (i) confirmation that the geographic information of the user of the service provider has been updated; or (ii) confirmation that the geographic information of the user of the service provider was not updated.

14. The system of claim 13, wherein the user reply to the notification comprises confirmation or denial of the authorization request.

15. The system of claim 13, wherein the user reply to the notification comprises a biometric parameter, a password, a passcode, or multi-factor authentication.
